(19) United States
(12) Patent Application Publication
(10) Pub. No.: US 2020/0079956 A1
(43) Pub. Date: Mar. 12, 2020

(54) POLYCARBONATE COMPOSITIONS HAVING GOOD MECHANICAL PROPERTIES

(71) Applicant: Covestro AG, Leverkusen (DE)

(72) Inventors: Andreas Seidel, Dormagen (DE); Sven Hobeika, Solingen (DE); Stephanie Barwinkel, Bayreuth (DE); Merve Demir, Bayreuth (DE); Volker Altstadt, Hamburg (DE)

(21) Appl. No.: 16/468,551

(22) PCT Filed: Dec. 22, 2017
(86) PCT No.: PCT/EP2017/084285

§ 371 Date: Jun. 11, 2019

(30) Foreign Application Priority Data
Dec. 28, 2016 (EP) 16207040.3

(51) Int. Cl. C08L 69/00; C08L 55/02; C08L 25/12; C08L 51/04; C08L 51/00

(52) U.S. Cl. CPC C08L 69/00; C08L 55/02; C08L 51/003; C08L 51/04; C08L 25/12

(57) ABSTRACT

The invention relates to compositions containing:
A) an aromatic polycarbonate and/or a polyester carbonate,
B) a rubber-based graft polymer having a graft sheath B.1) consisting of at least 95% by weight, based on the component B.1), of B.1.1) styrene and B.1.2) acrylonitrile and optionally not more than 5% by weight, based on the component B.1), of at least one further vinyl monomer B.1.3) copolymerizable with B.1.1) and B.1.2) and also a rubber-like graft substrate B.2),
C) a rubber-free copolymer consisting of at least 95% by weight, based on the component C), of C.1) styrene and C.2) acrylonitrile and optionally not more than 5% by weight, based on the component C), of at least one further vinyl monomer C.3) copolymerizable with C.1) and C.2),
and also to a process for producing the compositions, to the use of the compositions for producing moulded articles and to the moulded articles themselves.

The present invention relates to thermoplastic impact-modified polycarbonate compositions, to a process for producing thermoplastic polycarbonate compositions, to the use of the compositions for producing moulded articles and to the moulded articles themselves.

Polycarbonate compositions have been known for a long time, and these materials are used to produce moulded articles for a very wide variety of applications, for example in the automobile sector, for rail vehicles, for the construction sector, in the electrical/electronics sector and in domestic appliances. By varying the amount and type of the formulation constituents the compositions and thus also the produced moulded articles may be adapted over wide ranges in terms of their thermal, rheological and mechanical properties according to the requirements for the respective application.

Polycarbonate per se features very good heat resistance and high impact resistance at room temperature. In order to improve toughness at low temperatures the polycarbonate is blended with polymeric blend partnets having low glass transition temperatures as an elastic component.

Employed as such impact modifiers are for example graft polymers having a core-shell structure made of a butadiene-containing core and a graft sheath made of vinyl(co)polymer which is intended to ensure (a degree of) compatibility of the modifier with the polycarbonate and with any other polymer components present in the mixture. To realize a better melt flowability such compositions are often further admixed with for example free, i.e. not bonded to a graft substrate, vinyl (co)polymer. In a commercially customary embodiment both the vinyl copolymers of the graft sheath and the vinyl copolymers not bonded to a graft substrate are copolymers consisting of styrene and acrylonitrile (SAN). The free SAN and the SAN from the graft sheath may differ in terms of the molecular weights and the respective proportions of styrene and acrylonitrile.

PC/ABS compositions (polycarbonate/acrylonitrile/butadiene/styrene) having high toughness at low temperatures and characterized in that the graft polymers and/or the copolymers are at least partly replaced by graft polymers and/or copolymers in which the graft superstrate and/or the copolymer contains at least 86% by weight of vinyl aromatics, i.e. not more than 14% by weight of non-vinylaromatic comonomers such as for example acrylonitrile, are described in EP 0 372 336 A2. These applications also disclose PC/ABS compositions containing polycarbonate, ABS graft polymer and SAN copolymer in which the composition of the graft sheath of the ABS graft polymer and of the free SAN copolymer differ from one another. In the disclosed compositions, however, the acrylonitrile content in the SAN copolymer is either lower or not more than 1% by weight higher than in the SAN graft sheath of the respective ABS graft polymer.

DE 102 55 825 A1 discloses PC/ABS compositions having improved surface quality containing a mixture, obtained by coprecipitation, of at least one rubber-containing graft polymer produced by emulsion polymerization and at least one rubber-free thermoplastic vinyl (co)polymer produced by emulsion polymerization and at least one rubber-free thermoplastic vinyl (co)polymer produced by solution, bulk or suspension polymerization, wherein in a preferred embodiment the two rubber-free vinyl (co)polymers differ in acrylonitrile content by 1% to 15% by weight, preferably by 2% to 10% by weight, particularly preferably by 2.5% to 7.5% by weight. However, this application is silent about particular advantages when using different acrylonitrile contents in the graft sheath of the rubber-containing graft polymer and in one or both rubber-free vinyl (co)polymers.

EP 1 910 469 A1 discloses PC/ABS moulding materials having improved processing stability for producing complex mouldings for automotive construction which feature a combination of a good low-temperature toughness over a wide processing window and good stress cracking resistance under the action of chemicals and contain polycarbonate, ABS graft polymer and a mixture of two SAN polymers having different acrylonitrile contents. The examples in this document disclose compositions containing graft polymer having a SAN graft sheath having an acrylonitrile content of 28% by weight and the mixture of two SAN polymers having acrylonitrile content of 23% and 28% by weight. Thus, exclusively compositions in which the content of acrylonitrile in the free (i.e. not rubber-bonded) SAN is lower than the acrylonitrile content in the sheath of the graft polymer are disclosed.

EP 0 062 838 describes a thermoplastic moulding material consisting of a polycarbonate A, a graft mixed polymer B (for example ASA, ABS, AES), a copolymer C of styrene and/or α-methylstyrene with acrylonitrile, a terpolymer D and optionally customary additives. The moulding materials feature improved toughness and improved heat resistance. The moulding materials are used to produce mouldings by injection moulding for automobile construction.

EP 0 628 601 describes mixtures of an aromatic polycarbonate and an ABS graft copolymer. The mixture is used for producing moulded articles. The moulded articles feature reduced gloss and reduced opacity.

US 2009/143512) describes mixtures of a) 60-95 parts by weight of aromatic polycarbonate, b) 4-39 parts by weight of styrene-(meth)acrylonitrile copolymer grafted onto rubber and b′) 1-36 parts by weight of ungrafted styrene-(meth)acrylonitrile copolymer. The compositions feature good weld line strength.

Polycarbonate/ABS compositions are also used for producing mouldings having complex geometries or thin wall thicknesses. In the injection moulding processes employed the molten moulding material is often introduced into the mould at two or more locations simultaneously so that the finished component parts have weld lines at which the melt fronts collide during injection moulding. Particularly for polymer blends such weld lines generally constitute weak points in terms of mechanical strength. A suitable measure of the mechanical strength of the weld lines is weld line tensile strength.

Furthermore the moulded articles are not just exposed to rapid mechanical impact loads with high local stresses but rather smaller, optionally periodically occurring local mechanical stresses may also take effect over longer periods and may then result in material fatigue. A suitable measure for this type of material failure is fatigue cracking behaviour.

Finally, in addition to the mechanical stresses, the component parts may also be exposed to aggressive media such as cleaning compositions, disinfectant compositions or sunscreen, thus causing damage or material fractures.

This material property may be suitably described by means of the stress cracking resistance.

The prior art does not disclose how polycarbonate/ABS compositions may be improved in terms of weld line tensile strength, fatigue cracking behaviour, and stress cracking resistance.

It was therefore desirable to provide PC/ABS compositions featuring an advantageous combination of mechanical strength of weld lines, material fatigue behaviour and chemicals resistance.

It has now been found that, surprisingly, compositions containing
A) 10% to 90% by weight, preferably 40% to 90% by weight, particularly preferably 50% to 75% by weight, of aromatic polycarbonate and/or polyester carbonate,
B) 1% to 50% by weight, preferably 5% to 40% by weight, particularly preferably 10% to 30% by weight of rubber-based graft polymer having a graft sheath B.1) consisting of at least 95% by weight, preferably at least 97% by weight, particularly preferably at least 99% by weight, in each case based on the component B.1), of B.1.1) styrene and B.1.2) acrylonitrile and optionally not more than 5% by weight, preferably not more than 3% by weight, particularly preferably not more than 1% by weight, in each case based on the component B.1), of at least one further vinyl monomer B.1.3) copolymerizable with B.1.1) and B.1.2) and also a rubber-like, preferably particulate, graft substrate B.2),
C) 1% to 50% by weight, preferably 5% to 40% by weight, particularly preferably 10% to 30% by weight of rubber-free copolymer consisting of at least 95% by weight, preferably at least 97% by weight, particularly preferably at least 99% by weight, in each case based on the component C, of C.1) styrene and C.2) acrylonitrile and optionally not more than 5% by weight, preferably not more than 3% by weight, particularly preferably not more than 1% by weight, in each case based on the component C), of at least one further vinyl monomer C.3) copolymerizable with C.1) and C.2),
   characterized in that the content of acrylonitrile C.2) in the component C) is 1.5% to 8.0% by weight, preferably from 2.0% to 6.0% by weight, particularly preferably from 2.5% to 4.5% by weight, higher than the content of acrylonitrile B.1.2) in the graft sheath B.1) of component B) and in that the component C has a weight-average molecular weight Mw determined by gel permeation chromatography (GPC) in tetrahydrofuran with a polystyrene standard of 70 to 200 kDa,
   have the desired profile of properties.

The compositions may optionally contain as component D) polymer additives, preferably from 0.1% to 40% by weight, particularly preferably from 0.1% to 10% by weight.

In a further embodiment the graft sheath B.1) of the rubber-based graft polymer B) consists of B.1.1) styrene and B.1.2) acrylonitrile.

In a further embodiment the rubber-free copolymer C) consists of C.1) styrene and C.2) acrylonitrile.

Particular preference is given to the embodiment in which both the graft sheath B.1) of the rubber-based graft polymer B), and the rubber-free copolymer C), consist of styrene and acrylonitrile.

In a further embodiment a rubber-based graft polymer B) having a graft sheath B.1) consisting of at least 95% by weight, preferably at least 97% by weight, particularly preferably at least 99% by weight, in each case based on the component B.1), of B.1.1) styrene and B.1.2) acrylonitrile and optionally not more than 5% by weight, preferably not more than 3% by weight, particularly preferably not more than 1% by weight, in each case based on the component B.1), of at least one further vinyl monomer B.1.3) copolymerizable with B.1.1) and B.1.2) is employed,

wherein the weight ratio of the components B.1.1) to B.1.2) is in the range from 68/32 to 80/20, preferably 70/30 to 77/23 and particularly preferably 71/29 to 75/25.

In a further embodiment a rubber-based graft polymer B) having a graft sheath B.1) consisting of 68% to 80% by weight, preferably 70% to 77% by weight and particularly preferably 71% to 75% by weight of B.1.1) styrene and 20% to 32% by weight, preferably 23% to 30% by weight and particularly preferably 25% to 29% by weight of B.1.2) acrylonitrile is employed.

In a further embodiment the component B.1) consists of 71% to 75% by weight of B.1.1) styrene and 25% to 29% by weight of B.1.2) acrylonitrile and the component C) of 66.5% to 72.5% by weight of C.1) styrene and 27.5% to 33.5% by weight of C.2) acrylonitrile with the additional proviso that C.2) is 2.5% to 4.5% by weight higher than B.1.2).

In a further embodiment the compositions consist to an extent of at least 95% by weight of the components A), B), C) and D). In a preferred embodiment said compositions consist of the components A), B), C) and D).

In a further embodiment the weight ratio of the components B) to C) is in the range 1:3 to 3:1, preferably in the range from 1:2 to 2:1.

### Component A

Polycarbonates in the context of the present invention are either homopolycarbonates or copolycarbonates and/or polyester carbonates; the polycarbonates may be linear or branched in known fashion. According to the invention mixtures of polycarbonates may also be used.

The thermoplastic polycarbonates, including the thermoplastic, aromatic polyester carbonates, have average molecular weights M_{w} determined by GPC (gel permeation chromatography in methylene chloride with a polycarbonate standard) of 15000 g/mol to 50000 g/mol, preferably of 20000 g/mol to 35000 g/mol, particularly preferably of 23000 g/mol to 33000 g/mol, in particular of 24000 g/mol to 31000 g/mol.

A portion, up to 80 mol %, preferably from 20 mol % up to 50 mol %, of the carbonate groups in the polycarbonates employed in accordance with the invention may be replaced by aromatic dicarboxylic ester groups. Such polycarbonates, incorporating both acid radicals from the carbonic acid and acid radicals from aromatic dicarboxylic acids in the molecule chain, are referred to as aromatic polyester carbonates. In the context of the present invention they are subsumed within the generic term thermoplastic aromatic polycarbonates.

The polycarbonates are produced in a known manner from diphenols, carbonic acid derivatives, optionally chain terminators and optionally branching agents, and for the production of the polyester carbonates a portion of the carbonic acid derivatives is replaced by aromatic dicarboxylic acids or derivatives of the dicarboxylic acids according to the extent to which the carbonate structural units are to be replaced by aromatic dicarboxylic ester structural units in the aromatic polycarbonates.

Dihydroxyaryl compounds suitable for producing polycarbonates are those of formula (1)

HO—Z—OH (1),

in which
Z is an aromatic radical which has 6 to 30 carbon atoms and may contain one or more aromatic rings, may be substituted and may contain aliphatic or cycloaliphatic radicals or alkylaryls or heteroatoms as bridging elements.

It is preferable when Z in formula (1) stands for a radical of formula (2)

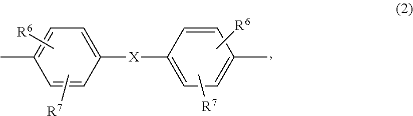

in which
R⁶ and R⁷ each independently of one another stand for H, C₁- to C₁₈-alkyl-, C₁- to C₁₈-alkoxy, halogen such as Cl or Br or respectively optionally substituted aryl- or aralkyl, preferably for H or C₁- to C₁₂-alkyl, particularly preferably for H or C₁- to C₈-alkyl and very particularly preferably for H or methyl, and
X stands for a single bond, —SO₂—, —CO—, —O—, —S—, C₁- to C₆-alkylene, C₂- to C₅-alkylidene or C₅- to C₆-cycloalkylidene which may be substituted with C₁- to C₆-alkyl, preferably methyl or ethyl, further for C₆- to C₁₂-arylene which may optionally be fused to further aromatic rings comprising heteroatoms.

X preferably stands for a single bond, C₁- to C₅-alkylene, C₂- to C₅-alkylidene, C₅- to C₆-cycloalkylidene, —O—, —SO—, —CO—, —S—, —SO₂—

or for a radical of formula (2a)

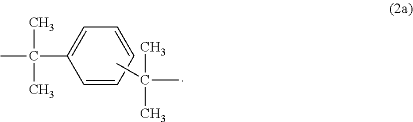

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Diphenols suitable for producing the polycarbonates for use in accordance with the invention are for example hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and the alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis [2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis [2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane (bisphenol A), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

2,2-bis(4-hydroxyphenyl)propane (bisphenol A) is especially preferred.

These and other suitable diphenols are described by way of example in U.S. Pat. Nos. 2,999,835 A, 3,148,172 A, 2,991,273 A, 3,271,367 A, 4,982,014 A and 2,999,846 A, in German laid-open specifications 1 570 703 A, 2 063 050 A, 2 036 052 A, 2 211 956 A and 3 832 396 A1, in the French patent specification 1 561 518, in the monograph by H. Schnell, “Chemistry and Physics of Polycarbonates”, Interscience Publishers, New York 1964, pp. 28ff and pp. 102ff., and in D. G. Legrand, J. T. Bendier, “Handbook of Polycarbonate Science and Technology”, Marcel Dekker, New York, 2000, pp. 72ff.

In the case of the homopolycarbonates, only one diphenol is used; in the case of copolycarbonates, two or more diphenols are used. The diphenols employed, similarly to all other chemicals and assistants added to the synthesis, may be contaminated with the contaminants from their own synthesis, handling and storage. However, it is desirable to use raw materials of the highest possible purity.

The monofunctional chain terminators required for molecular weight regulation, such as phenols or alkylphenols, in particular phenol, p-tert-butylphenol, isooctylphenol, cumylphenol, chlorocarbonic esters thereof or acyl chlorides of monocarboxylic acids or mixtures of these chain terminators, are either supplied to the reaction with the bisphenolate(s) or else are added at any desired juncture in the synthesis provided that phosgene or chlorocarbonic acid end groups are still present in the reaction mixture or, in the case of acyl chlorides and chlorocarbonic esters as chain terminators, as long as sufficient phenolic end groups of the resulting polymer are available. However, it is preferable when the chain terminator(s) is/are added after the phosgenation at a location or at a juncture at which phosgene is no longer present but the catalyst has not yet been metered into the system or when they are metered into the system before the catalyst or together or in parallel with the catalyst.

Any branching agents or branching agent mixtures to be used are added to the synthesis in the same manner, but typically before the chain terminators. Typically, trisphenols, quaterphenols or acid chlorides of tri- or tetracarboxylic acids are used, or else mixtures of the polyphenols or of the acid chlorides.

Some of the compounds having three or more than three phenolic hydroxyl groups that are usable as branching agents are, for example, phloroglucinol, 4,6-dimethyl-2,4,6-tri(4-hydroxyphenyl)hept-2-ene, 4,6-dimethyl-2,4,6-tri-(4-hydroxyphenyl)heptane, 1,3,5-tris(4-hydroxyphenyl)benzene, 1,1,1-tri-(4-hydroxyphenyl)ethane, tris(4-hydroxyphenyl)phenylmethane, 2,2-bis [4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of any branching agents to be used is 0.05 mol % to 2 mol %, based in turn on moles of respectively employed diphenols.

The branching agents may either be initially charged with the diphenols and the chain terminators in the aqueous alkaline phase or added dissolved in an organic solvent before the phosgenation.

All these measures for producing the polycarbonates are familiar to those skilled in the art.

Aromatic dicarboxylic acids suitable for producing the polyester carbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the diacyl dihalides and the dialkyl dicarbonates, in particular the diacyl dichlorides and the dimethyl dicarbonates.

Replacement of the carbonate groups by the aromatic dicarboxylic ester groups proceeds essentially stoichiometrically and also quantitatively and the molar ratio of the reaction partners is therefore also reflected in the final polyester carbonate. The incorporation of the aromatic dicarboxylic ester groups may be effected either randomly or else blockwise.

Preferred modes of production of the polycarbonates to be used according to the invention, including the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the first case the acid derivatives used are preferably phosgene and optionally diacyl dichlorides; in the latter case preferably diphenyl carbonate and optionally dicarboxylic diesters. Catalysts, solvents, work-up, reaction conditions, etc. for polycarbonate production and polyester carbonate production are sufficiently well described and known in both cases.

### Component B

Employed as component B) are rubber-modified graft polymers.

Rubber-modified graft polymers employed as component B) consist of
B.1) 5% to 95% by weight, preferably 15% to 92% by weight, in particular 25% to 60% by weight, based on component B), of a mixture consisting of at least 95% by weight, preferably at least 97% by weight, particularly preferably at least 99% by weight, in each case based on the component B.1), of B.1.1) styrene and B.1.2) acrylonitrile and optionally not more than 5% by weight, preferably not more than 3% by weight, particularly preferably not more than 1% by weight, in each case based on the component B.1), of at least one further vinyl monomer B.1.3) copolymerizable with B.1.1) and B.1.2) and
B.2) 95% to 5% by weight, preferably 85% to 8% by weight, in particular 75% to 40% by weight, based on component B), of one or more rubber-like, preferably particulate, graft substrates, preferably having glass transition temperatures <10° C., more preferably <0° C., particularly preferably <−20° C.,
   wherein the polymer chains formed from the monomers B.1) are chemically bonded to the graft substrate B.2) or are enclosed in the rubber particles such that during production and processing of the compositions according to the invention they do not escape from the rubber particles.

The glass transition temperature is determined by differential scanning calorimetry (DSC) according to the standard DIN EN 61006 (2004 version) at a heating rate of 10 K/min, T_{g} being defined as the mid-point temperature (tangent method).

The preferred particulate graft substrates B.2) generally have an average particle size (d₅₀ value) of 0.05 to 10 μm, preferably 0.1 to 5 μm, particularly preferably 0.2 to 1 μm.

The average particle size d₅₀ is the diameter with 50% by weight of the particles above it and 50% by weight of the particles below it. It can be determined by ultracentrifugation (W. Scholtan, H. Lange, Kolloid, Z. and Z. Polymere [polymers] 250 (1972), 782-1796).

The monomers B.1.3) are preferably selected from vinylaromatics distinct from B.1.1) (for example α-methylstyrene, p-methylstyrene, p-chlorostyrene), vinyl cyanides distinct from B.1.2) (for example methacrylonitrile), (meth)acrylic acid (C₁-C₈)-alkyl esters (for example methyl methacrylate, ethyl methacrylate, n-butyl acrylate, t-butyl acrylate) and/or derivatives (such as anhydrides and imides) of unsaturated carboxylic acids (for example maleic anhydride and N-phenylmaleimide).

Graft substrates B.2) suitable for the graft polymers B) are for example diene rubbers, EP(D)M rubbers, i.e. those based on ethylene/propylene and optionally diene, acrylate, polyurethane, silicone, chloroprene, ethylene/vinyl acetate rubbers and also silicone/acrylate composite rubbers.

Preferred graft substrates B.2) are diene rubbers, for example based on butadiene and isoprene, or mixtures of diene rubbers or copolymers of diene rubbers or mixtures thereof with further copolymerizable monomers (for example of B.1.1) and B.1.2)).

Particularly preferred as graft substrate B.2) is pure polybutadiene rubber.

Particularly preferred graft polymers B) are for example ABS polymers as described for example in DE-A 2 035 390 (=U.S. Pat. No. 3,644,574) or in DE-A 2 248 242 (=GB-B 1 409 275), or in Ullmanns, Enzyklopadie der Technischen Chemie, Vol. 19 (1980), p. 280 et seq.

The graft copolymers B) are produced by free-radical polymerization, for example by emulsion, suspension, solution or bulk polymerization, preferably by emulsion or bulk polymerization, in particular by emulsion polymerization.

The gel content of the graft substrate B.2) is at least 30% by weight, preferably at least 40% by weight, in particular at least 60% by weight, in each case based on B.2) and measured as insoluble fraction in toluene.

The gel content of the graft substrate B.2) is determined at 25° C. in a suitable solvent as content insoluble in these solvents (M. Hoffmann, H. Kromer, R. Kuhn, Polymeranalytik I and II, Georg Thieme-Verlag, Stuttgart 1977).

Particularly suitable graft polymers B) also include ABS polymers produced by redox initiation with an initiator system of organic hydroperoxide and ascorbic acid according to U.S. Pat. No. 4,937,285.

As is well known, during grafting the graft monomers B.1) are not necessarily grafted onto the graft substrate completely. Products of grafting reactions thus often still contain significant proportions of free (i.e. not chemically bonded to the graft substrate) copolymer having a composition analogous to that of the graft sheath. In the context of the present invention component B) is to be understood as meaning exclusively the graft polymer as defined above while the copolymer not chemically bonded to the graft substrate and not enclosed in the rubber particles which is present as a consequence of manufacture is assigned to component C).

The proportion of this free copolymer in the products of grafting reactions may be determined from the gel contents thereof (proportion of free copolymer=100% by weight−gel content of the product in % by weight), wherein the gel content is determined at 25° C. in a suitable solvent (such as for instance acetone) as content insoluble in these solvents.

Suitable acrylate rubbers of B.2) are preferably polymers of alkyl acrylates, optionally with up to 40% by weight, based on B.2), of other polymerizable ethylenically unsaturated monomers. The preferred polymerizable acrylates include C₁ to C₈-alkyl esters, for example methyl-, ethyl-, butyl-, n-octyl- and 2-ethylhexyl esters; haloalkyl esters, preferably halo-C₁-C₈-alkyl esters, such as chloroethyl acrylate and also mixtures of these monomers.

Monomers having more than one polymerizable double bond can be copolymerized for crosslinking purposes. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on the graft substrate B.2). The amount of cyclic crosslinking monomers having at least three ethylenically unsaturated groups is advantageously restricted to less than 1% by weight of the graft substrate B.2).

Further suitable graft substrates of B.2) are silicone rubbers having grafting-active sites, such as are described in DE-A 3 704 657, DE-A 3 704 655, DE-A 3 631 540 and DE-A 3 631 539.

In a further embodiment a rubber-based graft polymer B) having a graft sheath B.1) consisting of at least 95% by weight, preferably at least 97% by weight, particularly preferably at least 99% by weight, in each case based on the component B.1), of B.1.1) styrene and B.1.2) acrylonitrile and optionally not more than 5% by weight, preferably not more than 3% by weight, particularly preferably not more than 1% by weight, in each case based on the component B.1), of at least one or more vinyl monomers B.1.3) copolymerizable with B.1.1) and B.1.2) is employed, wherein the weight ratio of the components B.1.1) to B.1.2) is in the range from 68/32 to 80/20, preferably 70/30 to 77/23 and particularly preferably 71/29 to 75/25.

In a particularly preferred embodiment a rubber-based graft polymer B) having a graft sheath B.1) consisting of 68% to 80% by weight, preferably 70% to 77% by weight, particularly preferably 71% to 74% by weight of B.1.1) styrene and 20% to 32% by weight, preferably 23% to 30% by weight, particularly preferably 26% to 29% by weight of B.1.2) acrylonitrile, is employed.

In a further embodiment the amount of rubber in the composition calculated as the product of the amount of the component B) in the composition in % by weight and the weight fraction of the component B.2) in B) is between 7% and 15% by weight.

### Component C

The composition contains as further component C) rubber-free copolymer consisting of at least 95% by weight, preferably at least 97% by weight, particularly preferably at least 99% by weight, in each case based on the component C), of C.1) styrene and C.2) acrylonitrile and optionally not more than 5% by weight, preferably not more than 3% by weight, particularly preferably not more than 1% by weight, in each case based on the component C), of at least one further vinyl monomer C.3) copolymerizable with C.1) and C.2) and selected from the group comprising vinylaromatics distinct from C.1) (for example α-methylstyrene, p-methylstyrene, p-chlorostyrene), vinyl cyanides distinct from C.2) (for example methacrylonitrile), (meth)acrylic acid-(C₁-C₈)-alkyl esters (for example methyl methacrylate, ethyl methacrylate, n-butyl acrylate, t-butyl acrylate) and/or derivatives (such as anhydrides and imides) of unsaturated carboxylic acids (for example maleic anhydride and N-phenylmaleimide).

Particularly preferably suitable as component C) are rubber-free copolymers consisting of C.1) styrene and C.2) acrylonitrile.

The respective proportions of C.1) and C.2) in component C) arise from the proportions of B.1.1) and B.1.2) in the graft sheath B.1) of the component B) according to the description of the component B) and the claimed feature that the content of acrylonitrile C.2) in the component C) is 1.5% to 8.0% by weight, preferably from 2.0% to 6.0% by weight, particularly preferably from 2.5% to 4.5% by weight, higher than the content of acrylonitrile B.1.2) in the graft sheath B.1) of component B).

These rubber-free copolymers C) are resinous, thermoplastic and rubber-free.

Such rubber-free copolymers C) are known and may be produced by free-radical polymerization, in particular by emulsion, suspension, solution or bulk polymerization.

The rubber-free copolymer C) has a weight-average molecular weight Mw determined by gel permeation chromatography (GPC) in tetrahydrofuran with a polystyrene standard of 70 to 200, preferably 70 to 170 kDa, more preferably of 80 to 150 kDa, particularly preferably of 90 to 140 kDa, very particularly preferably of 95 to 120 kDa.

Also employable as component C) are mixtures of a plurality of rubber-free copolymers of different monomer composition and/or different molecular weight, in each case consisting of at least 95% by weight, preferably of at least 97% by weight, particularly preferably of at least 99% by weight, in each case based on the individual rubber-free copolymer, of C.1) styrene and C.2) acrylonitrile and optionally not more than 5% by weight, preferably not more than 3% by weight, particularly preferably not more than 1% by weight, in each case based on the individual rubber-free copolymer, of at least one further vinyl monomer C.3) copolymerizable with C.1) and C.2) and selected from the group comprising vinylaromatics distinct from C.1) (for example α-methylstyrene, p-methylstyrene, p-chlorostyrene), vinyl cyanides distinct from C.2) (for example methacrylonitrile), (meth)acrylic acid-(C1-C8)-alkyl esters (for example methyl methacrylate, ethyl methacrylate, n-butyl acrylate, t-butyl acrylate) and/or derivatives (such as anhydrides and imides) of unsaturated carboxylic acids (for example maleic anhydride and N-phenylmaleimide).

In this case in which as component C) mixtures of a plurality of rubber-free copolymers of different monomer composition and/or different molecular weight are employed, each individual rubber-free copolymer C) contains styrene and acrylonitrile in a weight ratio of 90/10 to 60/40. Furthermore, each individual rubber-free copolymer C) has a weight-average molecular weight Mw determined by gel permeation chromatography (GPC) in tetrahydrofuran with a polystyrene standard of 70 to 200 kDa.

In the case where as component C) a mixture of a plurality of rubber-free copolymers of different monomer composition and/or different molecular weight is employed, the abovementioned specifications and preferred ranges apply having regard to the monomer composition and the molecular weight of the component C) for the respective average values, weighted with the mass fractions, for all rubber-free copolymers in the composition.

### Component D

The composition may contain as component D one or more further additives preferably selected from the group consisting of flame retardants (for example organic phosphorus or halogen compounds, in particular bisphenol-A-based oligophosphate), anti-drip agents (for example compounds from the classes of fluorinated polyolefins, silicones, and also aramid fibres), flame retardant synergists (for example nanoscale metal oxides), smoke inhibitors (for example zinc borate), lubricants and demoulding agents (for example pentaerythritol tetrastearate), nucleating agents, antistats, conductivity additives, stabilizers (e.g. hydrolysis, heat-ageing and UV stabilizers, and also transesterification inhibitors and acid/base quenchers), flow promoters, compatibilizers, further impact modifiers distinct from component B (with or without core-shell structure), further polymeric constituents (for example functional blend partners), fillers and reinforcers (for example glass or carbon fibres, talc, mica, kaolin, CaCO₃) and also dyes and pigments (for example titanium dioxide or iron oxide).

In a preferred embodiment the composition is free from flame retardants, anti-drip agents, flame retardant synergists and smoke inhibitors.

In a likewise preferred embodiment the composition is free from fillers and reinforcing materials.

In a particularly preferred embodiment the composition is free from flame retardants, anti-drip agents, flame retardant synergists, smoke inhibitors and fillers and reinforcing materials.

In a preferred embodiment the composition contains at least one polymer additive selected from the group consisting of lubricants and demoulding agents, stabilizers, flow promoters, compatibilizers, further impact modifiers distinct from component B, further polymeric constituents, dyes and pigments.

In a preferred embodiment the compositions contain no polyester.

In a particularly preferred embodiment the composition contains at least one polymer additive selected from the group consisting of lubricants and demoulding agents, stabilizers, flow promoters, compatibilizers, further impact modifiers distinct from component B, dyes and pigments and is free from further polymer additives.

In a preferred embodiment the composition contains at least one polymer additive selected from the group consisting of lubricants/demoulding agents and stabilizers.

In a particularly preferred embodiment the composition contains at least one polymer additive selected from the group consisting of lubricants/demoulding agents, stabilizers, dyes and pigments, and is free from other polymer additives.

In a preferred embodiment the composition contains pentaerythritol tetrastearate as a demoulding agent.

In a preferred embodiment the composition contains as a stabilizer at least one representative selected from the group consisting of sterically hindered phenols, organic phosphites, sulfur-based co-stabilizers and organic and inorganic Brønsted acids.

In a particularly preferred embodiment the composition contains as a stabilizer at least one representative selected from the group consisting of octadecyl 3-(3,5-di-tert-butyl-4-hydroxyphenyl)propionate and tris(2,4-di-tert-butylphenyl) phosphite.

In an especially preferred embodiment the composition contains as a stabilizer a combination of octadecyl 3-(3,5-di-tert-butyl-4-hydroxyphenyl)propionate and tris(2,4-di-tert-butylphenyl) phosphite.

Particularly preferred compositions contain pentaerythritol tetrastearate as a demoulding agent, at least one representative selected from the group consisting of octadecyl 3-(3,5-di-tert-butyl-4-hydroxyphenyl)propionate and tris(2,4-di-tert-butylphenyl) phosphite as a stabilizer and optionally a Brønsted acid and are free from further polymer additives.

More preferred compositions contain pentaerythritol tetrastearate as a demoulding agent, a combination of octadecyl 3-(3,5-di-tert-butyl-4-hydroxyphenyl)propionate and tris(2,4-di-tert-butylphenyl)phosphite as a stabilizer, optionally a Brønsted acid and are free from further polymer additives.

Further embodiments 1 to 25 of the present invention are described below:
1. Compositions containing
A) 10% to 90% by weight of aromatic polycarbonate and/or polyester carbonate,
B) 1% to 50% by weight of rubber-based graft polymer having a graft sheath B.1) consisting of at least 95% by weight, based on the component B.1), of B.1.1) styrene and B.1.2) acrylonitrile and optionally not more than 5% by weight, based on the component B.1), of at least one further vinyl monomer B.1.3) copolymerizable with B.1.1) and B.1.2) and also a rubber-like graft substrate B.2),
C) 1% to 50% by weight of rubber-free copolymer consisting of at least 95% by weight, based on the component C), of C.1) styrene and C.2) acrylonitrile and optionally not more than 5% by weight, based on the component C), of at least one further vinyl monomer C.3) copolymerizable with C.1) and C.2),
   characterized in that the content of acrylonitrile C.2) in the component C) is 1.5% to 8.0% by weight higher than the content of acrylonitrile B.1.2) in the graft sheath B.1) of component B) and in that the component C has a weight-average molecular weight Mw determined by gel permeation chromatography (GPC) in tetrahydrofuran with a polystyrene standard of 70 to 200 kDa.
2. Compositions according to embodiment 1, wherein the weight ratio of the components B.1.1) to B.1.2) is in the range from 68/32 to 80/20.
3. Compositions according to any of the preceding embodiments, wherein the component B.1) consists to an extent of at least 97% by weight, based on the component B.1), of B.1.1) styrene and B.1.2) acrylonitrile and optionally not more than 3% by weight, based on the component B.1), of at least one further vinyl monomer B.1.3) copolymerizable with B.1.1) and B.1.2).
4. Compositions according to any of the preceding embodiments, wherein the component B.1) consists to an extent of at least 99% by weight, based on the component B.1), of B.1.1) styrene and B.1.2) acrylonitrile and optionally not more than 1% by weight, based on the component B.1), of at least one further vinyl monomer B.1.3) copolymerizable with B.1.1) and B.1.2).
5. Compositions according to any of the preceding embodiments, wherein the component B.1) consists of B.1.1) styrene and B.1.2) acrylonitrile.
6. Compositions according to any of the preceding embodiments, containing
   40% to 90% by weight of the component A),
   5% to 40% by weight of the component B),
   5% to 40% by weight of the component C),
   0.1% to 40% by weight of polymer additives as component D).
7. Compositions according to any of the preceding embodiments, containing
   50% to 75% by weight of the component A),
   10% to 30% by weight of the component B),
   10% to 30% by weight of the component C),
   0.1% to 10% by weight of the component D).
8. Compositions according to any of the preceding embodiments, wherein the weight ratio of the components B) to C) is in the range 1:3 to 3:1.
9. Compositions according to any of the preceding embodiments, wherein the weight ratio of the components B) to C) is in the range 1:2 to 2:1.
10. Compositions according to any of the preceding embodiments, wherein the component C) has a weight-average molecular weight Mw of 70 to 170 kDa determined by gel permeation chromatography (GPC) in tetrahydrofuran with a polystyrene standard.
11. Compositions according to any of the preceding embodiments, wherein the component C) has a weight-average molecular weight Mw of 80 to 150 kDa determined by gel permeation chromatography (GPC) in tetrahydrofuran with a polystyrene standard.
12. Compositions according to any of the preceding embodiments, wherein the component C) has a weight-average molecular weight Mw of 90 to 140 kDa determined by gel permeation chromatography (GPC) in tetrahydrofuran with a polystyrene standard.
13. Compositions according to any of the preceding embodiments, wherein the component C) has a weight-average molecular weight Mw of 95 to 120 kDa determined by gel permeation chromatography (GPC) in tetrahydrofuran with a polystyrene standard.
14. Compositions according to any of the preceding embodiments, wherein the component B) consists to an extent of 8% to 85% by weight of a rubber-like and particulate graft substrate B.2) having a glass transition temperature of <0° C.
15. Compositions according to any of the preceding embodiments, wherein the component B) consists to an extent of 40% to 75% by weight of a rubber-like and particulate graft substrate B.2) having a glass transition temperature of <−20° C.
16. Compositions according to any of the preceding embodiments, wherein the content of acrylonitrile C.2) in the component C) is 2.0% to 6.0% by weight higher than the content of acrylonitrile B.1.2) in the graft sheath of component B).
17. Compositions according to any of the preceding embodiments, wherein the content of acrylonitrile C.2) in the component C) is 2.5% to 4.5% by weight higher than the content of acrylonitrile B.1.2) in the graft sheath of component B).
18. Compositions according to any of the preceding embodiments, wherein the weight ratio of the components B.1.1) to B.1.2) is in the range from 70/30 to 77/23.
19. Compositions according to any of the preceding embodiments, wherein the weight ratio of the components B.1.1) to B.1.2) is in the range from 71/29 to 75/25.
20. Compositions according to any of the preceding embodiments, wherein the amount of rubber in the composition calculated as the product of the amount of the component B) in the composition in % by weight and the weight fraction of the component B.2) in B) is between 7% and 15% by weight.
21. Compositions according to any of the preceding embodiments, wherein as component D) at least one polymer additive selected from the group consisting of lubricants and demoulding agents, stabilizers, flow promoters, compatibilizers, further impact modifiers distinct from component B, dyes and pigments is employed and the compositions are free from further polymer additives.
22. Compositions according to any of the preceding embodiments, wherein the compositions consist to an extent of at least 95% by weight of the components A), B), C) and D).
23. Compositions according to any of the preceding embodiments, wherein the compositions consist of the components A), B), C) and D).
24. Use of compositions of any of embodiments 1 to 23 for producing moulded articles.
25. Moulded articles produced from compositions according to any of embodiments 1 to 23.

### Production of the Moulding Materials and Moulded Articles

The thermoplastic moulding materials according to the invention may be produced for example by mixing the respective constituents and melt compounding and melt extruding the resulting mixture at temperatures of preferably 200° C. to 320° C., more preferably at 240° C. to 300° C., in customary apparatuses, for example internal kneaders, extruders and twin-shaft screw systems, in a known manner.

The mixing of the individual constituents may be effected in known fashion, either successively or simultaneously, either at about 20° C. (room temperature) or at a higher temperature.

The invention also provides a process for producing the compositions according to the invention.

The moulding materials according to the invention may be used for producing moulded articles of any kind. These may be produced by injection moulding, extrusion and blow-moulding processes for example Another type of processing is the production of moulded articles by thermoforming from prefabricated sheets or films.

Examples of such moulded articles are films, profiles, housing parts of any type, e.g. for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions according to the invention are also suitable for the production of the following moulded articles or moulded parts: Internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

### EXAMPLES

### Component A:

Linear polycarbonate based on bisphenol A having a weight-average M_{w} molecular weight of 32 000 g/mol (determined by GPC in methylene chloride with a polycarbonate standard).

### Component B:

Graft polymer of 40 parts by weight of a mixture of styrene and acrylonitrile in a % by weight ratio of 72:28 on 60 parts by weight of a particulate crosslinked polybutadiene rubber (d₅₀ particle diameter=0.3 μm) produced by emulsion polymerization.

### Component C-1:

SAN copolymer having an acrylonitrile content of 15% by weight and a weight-average molecular weight of 132000 g/mol (determined by GPC in tetrahydrofuran with a polystyrene standard).

### Component C-2:

SAN copolymer having an acrylonitrile content of 25% by weight and a weight-average molecular weight of 93000 g/mol (determined by GPC in tetrahydrofuran with a polystyrene standard).

### Component C-3:

SAN copolymer having an acrylonitrile content of 28% by weight and a weight-average molecular weight of 80000 g/mol (determined by GPC in tetrahydrofuran with a polystyrene standard).

### Component C-4:

SAN copolymer having an acrylonitrile content of 31% by weight and a weight-average molecular weight of 100000 g/mol (determined by GPC in tetrahydrofuran with a polystyrene standard).

### Component C-5:

SAN copolymer having an acrylonitrile content of 31% by weight and a weight-average molecular weight of 63000 g/mol (determined by GPC in tetrahydrofuran with a polystyrene standard).

### Component C-6:

SAN copolymer having an acrylonitrile content of 38% by weight and a weight-average molecular weight of 100000 g/mol (determined by GPC in tetrahydrofuran with a polystyrene standard).

### Component C-7:

SAN copolymer having an acrylonitrile content of 38% by weight and a weight-average molecular weight of 51000 g/mol (determined by GPC in tetrahydrofuran with a polystyrene standard).

Component D: Heat stabilizer, Irganox® B900 (mixture of 80% Irgafos® 168 (tris(2,4-di-tert-butylphenyl)phosphite) and 20% Irganox® 1076 (2,6-di-tert-butyl-4-(octadecanoxycarbonylethyl)phenol); BASF (Ludwigshafen, Germany)).

### Production and Testing of the Moulding Materials of the Invention

The mixing of the components was performed on a ZSK 26 MCC twin-screw extruder from Coperion at a melt temperature of 275° C. The moulded articles were produced at a melt temperature of 260° C. and a mould temperature of 80° C. on Arburg 270 (weld line tensile bars and test bars for chemicals resistance test) or Battenfeld HM 110/525 (test specimens for evaluating fatigue cracking behaviour) injection moulding machines.

The weld line tensile strength was measured according to DIN EN ISO 527-2 (2012 version). To this end, tensile bars having sample dimensions of 170 mm×10 mm×4 mm and produced with a double sprue on both sides of the bar, thus having a weld line in the middle of the specimen, were tested on a Zwick Z020 universal testing machine from Zwick GmbH & Co. KG (Ulm, Germany) at room temperature (23° C.) and with an expansion rate of 50 mm/min.

Stress cracking resistance (ESC) in rapeseed oil at room temperature was used as a measure for chemicals resistance. The time until stress cracking-induced fracture failure of a test specimen having dimensions of 80 mm×10 mm×4 mm injection-moulded under the above-described conditions and subjected to 2.4% external outer fibre strain by means of a clamping template while completely immersed in the medium was determined. Measurement was performed according to DIN EN ISO 22088 (2006 version).

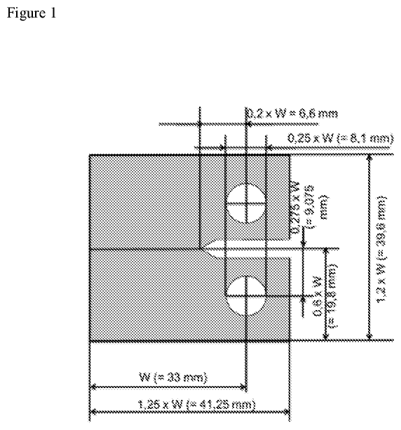

To evaluate fatigue cracking behaviour the CT test specimens depicted in FIG. 1 were used. To this end, sheets having a geometry of 70 mm×70 mm×4 mm were initially produced under the abovementioned conditions by injection moulding. The CT injection mouldings (dimensions as per FIG. 1) were then obtained therefrom by sawing with a diamond saw and drilling. The notch having a V-shaped geometry extends in the injection moulding direction.

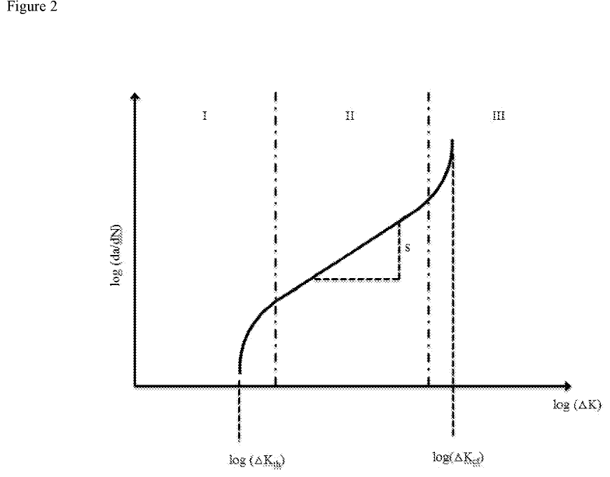

The measurement was performed according to ISO 15850 (2002 version) at room temperature (23° C.) and at 50% relative atmospheric humidity by means of a Hydropuls MHF computer-controlled universal servo-hydraulic testing machine (Instron GmbH, Darmstadt). Testing was performed with a sinusoidal stress load with a frequency of 10 Hz and a minimum to maximum stress load ratio R of 0.2. The amplitude ΔK between the maximum and the minimum stress intensity factor K during the sinusoidal dynamic loading was determined according to the abovementioned standard and the crack growth rate da/dN (=crack length increase in millimetres per cycle) was plotted in double logarithmic form against AK (units of MPa·m^{1/2}) which was continuously increased during the measurement. A schematic diagram of such a plot is shown in FIG. 2 with the parameters describing fatigue cracking behaviour that are derived therefrom. The determined parameters describing fatigue cracking behaviour were:
a) gradient s in the linear subregion (region II) of the abovementioned double logarithmic plot according to FIG. 2. This value describes how severely the crack growth rate da/dN increases when increasing loading. The greater this value, the faster failure will take place when increasing loading, i.e. relatively small values are desirable.
b) threshold stress intensity factor amplitude ΔKₜₕ. This is a measure for the local loading that must be exceeded in order for a crack to begin to grow. The value is read off according to FIG. 2. A value as high as possible is desirable.
c) critical stress intensity factor amplitude ΔK_{cf}. This is a measure for the local loading above which the crack growth rate becomes unstable, thus resulting in failure by fracture. The value is read off according to FIG. 2. A value as high as possible is desirable.

A good fatigue cracking behaviour is thus characterized by a low gradient s and the highest possible values for the threshold stress intensity factor amplitude ΔKₜₕ and the critical stress intensity factor amplitude ΔK_{cf}.

TABLE 1

| | V1 | V2 | V3 | 4 | V5 | V6 | V7 |
|---|---|---|---|---|---|---|---|
| Component | | | | | | | |
| A | 60 | 60 | 60 | 60 | 60 | 60 | 60 |
| B | 16 | 16 | 16 | 16 | 16 | 16 | 16 |
| C-l | 24 | | | | | | |
| C-2 | | 24 | | | | | |
| C-3 | | | 24 | | | | |
| C-4 | | | | 24 | | | |
| C-5 | | | | | 24 | | |
| C-6 | | | | | | 24 | |
| C-7 | | | | | | | 24 |
| D | 0.1 | 0.1 | 0.1 | 0.1 | 0.1 | 0.1 | 0.1 |
| Properties | | | | | | | |
| Weld line tensile | 35 | 36 | 38 | 42 | 38 | 40 | 37 |
| strength [MPa] | | | | | | | |
| Fatigue cracking | | | | | | | |
| behaviour | | | | | | | |
| s | 3.5 | 3.2 | n.m. | 3.0 | 3.1 | 3.2 | 3.8 |
| ΔKₜₕ [MPa m^{1/2}] | 0.42 | 0.39 | n.m. | 0.45 | 0.43 | 0.37 | 0.36 |
| ΔK_{cf} [MPa m^{1/2}] | 3.69 | 3.75 | n.m. | 3.96 | 3.72 | 3.54 | 3.47 |
| ESC (time until | 14 | 8 | 8 | 31 | 13 | 46 | n.m. |
| fracture in rapeseed | | | | | | | |
| oil @ 2.4%) [h] | | | | | | | |

The results shown in table 1 show that an advantageous combination of high weld line tensile strength, good fatigue cracking behaviour and high chemicals resistance can only be achieved with the claimed composition (example 4).

1. A composition comprising:
A) 10% to 90% by weight of an aromatic polycarbonate and/or a polyester carbonate,
B) 1% to 50% by weight of a rubber-based graft polymer having a graft sheath B.1) consisting of at least 95% by weight, based on the component B.1), of B.1.1) styrene and B.1.2) acrylonitrile and optionally not more than 5% by weight, based on the component B.1), of at least one further vinyl monomer B.1.3) copolymerizable with B.1.1) and B.1.2) and also a rubber-like graft substrate B.2),
C) 1% to 50% by weight of a rubber-free copolymer consisting of at least 95% by weight, based on the component C), of C.1) styrene and C.2) acrylonitrile and optionally not more than 5% by weight, based on the component C), of at least one further vinyl monomer C.3) copolymerizable with C.1) and C.2),
wherein the content of acrylonitrile C.2) in the component C) is 1.5% to 8.0% by weight higher than the content of acrylonitrile B.1.2) in the graft sheath B.1) of component B) and wherein the component C has a weight-average molecular weight Mw determined by gel permeation chromatography (GPC) in tetrahydrofuran with a polystyrene standard of 70 to 200 kDa,

2. The composition according to claim 1, wherein the weight ratio of the components B.1.1) to B.1.2) is in the range from 68/32 to 80/20.

3. The composition according to claim 1, wherein the component B.1) consists of B.1.1) styrene and B.1.2) acrylonitrile.

4. The composition according to claim 1, comprising
40% to 90% by weight of the component A),
5% to 40% by weight of the component B),
5% to 40% by weight of the component C), and
0.1% to 40% by weight of polymer additives as a component D).

5. The composition according to claim 1, comprising
50% to 75% by weight of the component A),
10% to 30% by weight of the component B),
10% to 30% by weight of the component C), and
0.1% to 10% by weight of a component D).

6. The composition according to claim 1, wherein the weight ratio of the components B) to C) is in the range 1:3 to 3:1.

7. The composition according to claim 4, wherein the composition consists to an extent of at least 95% by weight of the components A), B), C) and D).

8. The composition according to claim 1, wherein the component C) has a weight-average molecular weight Mw of 90 to 140 kDa determined by gel permeation chromatography (GPC) in tetrahydrofuran with a polystyrene standard.

9. The composition according to claim 1, wherein the component B) consists to an extent of 40% to 75% by weight of a rubber-like and particulate graft substrate B.2) having a glass transition temperature of <−20° C., with the balance of component B) being component B.1).

10. The composition according to claim 1, wherein the content of acrylonitrile C.2) in the component C) is 2.5% to 4.5% by weight higher than the content of acrylonitrile B.1.2) in the graft sheath of component B).

11. The composition according to claim 1, wherein the weight ratio of the components B.1.1) to B.1.2) is in the range from 71/29 to 75/25.

12. The composition according to claim 1, wherein the amount of rubber in the composition calculated as the product of the amount of the component B) in the composition in % by weight and the weight fraction of the component B.2) in B) is between 7% and 15% by weight.

13. The composition according to claim 1, further comprising as a component D) at least one polymer additive selected from the group consisting of: lubricants and demoulding agents, stabilizers, flow promoters, compatibilizers, further impact modifiers distinct from component B, dyes, and pigments is employed, and the composition is free from further polymer additives.

14. A process for the production of a moulded article, the process comprising:
utilizing the composition according to claim 1.

15. A moulded article produced from the composition according to claim 1.
